(19) United States
(12) Patent Application Publication
(10) Pub. No.: US 2010/0253976 A1
(43) Pub. Date: Oct. 7, 2010

(54) IMAGE PROCESSING APPARATUS AND METHOD OF SETTING IMAGE PROCESSING APPARATUS

(75) Inventor: Tsutomu Kasai, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/753,779

(22) Filed: Apr. 2, 2010

(30) Foreign Application Priority Data
Apr. 6, 2009 (JP) 2009-092274
Nov. 25, 2009 (JP) 2009-267182

(51) Int. Cl. G06F 15/00

(52) U.S. Cl. 358/1.15

(57) ABSTRACT

An image processing apparatus connected to another image processing apparatus via a network is provided. The image processing apparatus includes: a setting information storing unit that stores setting information; a request receiving unit that receives a request relating to setting content of the another image processing apparatus; and a setting unit that executes a setting process of performing setting on the another image processing apparatus on the basis of the setting information stored by the setting information storing unit, in response to the request received by the request receiving unit.

### BACKGROUND

1. Technical Field

The present invention relates to an image processing apparatus and the like which is used in the state of being connected to a network, and particularly, relates to an image processing apparatus and the like capable of improving user convenience with respect to a setting process of the other image processing apparatuses connected to the network.

2. Related Art

Hitherto, there may have been a case where image processing apparatuses such as a printer, a facsimile, and a scanner were used in the state of being connected to a personal computer via the network. When the image processing apparatus is used in such a network environment, it is necessary that contents of various operating conditions set in the image processing apparatus are set to contents suitable for the network environment.

Such a setting action may be performed from, for example, an operating panel provided in the image processing apparatus. In this case, a user performs a sequential input operation on items to be set with reference to a manual and the like.

In addition, it is possible to perform the setting process from a host device such as the personal computer via the network. In this case, a user installs exclusive software for the image processing apparatus of which the setting is performed in the host device, and then the user can perform the setting of the image processing apparatus intended to be set by performing an input action in accordance with instructions of the software.

Further, JP-A-2000-122944 proposes an apparatus in which setting of a network device is easily performed, and discloses that a personal computer performs setting of a device selected by a user.

However, in the setting for conforming to the network environment, the above-mentioned method of performing the setting from the operating panel has a drawback that since a user sequentially sets numerous setting items one by one, much time is taken, and a large burden is placed on the user.

In addition, the above-mentioned method in which exclusive software is installed in the host device such as a personal computer, there is a drawback that a user needs to perform installation of the software, and it may not function properly depending on the OS, therefore convenience is not very high. Further, since the software automatically performs an exchange of information with other devices via the network, there are users feeling anxious regarding security.

In addition, JP-A-2000-122944 also has a similar problem due to using a personal computer.

### SUMMARY

An advantage of some aspects of the invention is that it provides an image processing apparatus which is used in the state of being connected to a network, and an image processing apparatus capable of improving user convenience with respect to setting processes of other image processing apparatuses connected to the network.

According to a first aspect of the invention, an image processing apparatus connected to another image processing apparatus via a network is provided. The image processing apparatus includes: a setting information storing unit that stores setting information; a request receiving unit that receives a request relating to setting content of the another image processing apparatus; and a setting unit that executes a setting process of performing setting on the another image processing apparatus on the basis of the setting information stored by the setting information storing unit, in response to the request received by the request receiving unit.

It is preferable that the setting unit executes the setting process by copying the setting information stored by the setting information storing unit to the another image processing apparatus.

It is preferable that the setting unit executes the setting process on the basis of setting content, instructed by a user, which is received by the request receiving unit.

It is preferable that the setting unit executes the setting process on setting content other than setting content relating to an environment of the network.

It is preferable that the setting information stored by the setting information storing unit is setting information relating to a device itself.

It is preferable that another image processing apparatus having setting information relating to a device itself is further connected to the image processing apparatus, the image processing apparatus further includes a setting information acquiring unit that acquires the setting information from the another image processing apparatus having the setting information, and the setting information storing unit stores the acquired setting information.

It is preferable that another image processing apparatus having setting information different from setting information relating to a device itself is further connected to the image processing apparatus, the image processing apparatus further includes a setting information acquiring unit that acquires the setting information from the another image processing apparatus having the different setting information, and the setting information storing unit stores the acquired setting information.

It is preferable that the request receiving unit prepares and transmits a Web page for receiving the request relating to the setting content of the another image processing apparatus, and receives the request relating to the setting content of the another image processing apparatus on the basis of a response to the transmitted Web page.

It is preferable that the setting unit searches the another image processing apparatus connected to the network in response to a search request from a user which is received by the request receiving unit, the request receiving unit prepares and transmits a Web page that displays the another image processing apparatus connected to the network in a selectable manner as a result of the search, and the request receiving unit receives a request by selection instructions of the user to a display of the Web page, so that the another image processing apparatus executing the setting process is determined.

According to a second of the invention, a method of setting another image processing apparatus in an image processing apparatus connected to the another image processing apparatus via a network is provided. The method includes: receiving a request relating to setting content of the another image processing apparatus; and executing a setting process of performing setting on the image processing apparatus on the basis of the setting content of the image processing apparatus, in response to the request received by the receiving step.

The foregoing, features and advantages of the invention are obvious from embodiments of the invention described below.

### BRIEF DESCRIPTION OF THE DRAWINGS

The invention will be described with reference to the accompanying drawings, wherein like numbers reference like elements.

FIG. 1 is a configuration diagram according to an embodiment of an image processing apparatus to which the invention is applied.

FIG. 2 is a configuration diagram of a controller section.

FIG. 3 is a functional configuration diagram with respect to a section in which a setting process of a printer is performed.

FIG. 4 is a diagram illustrating a communication sequence between each of the equipment which is performed at the timing of the setting process.

FIG. 5 is a flowchart illustrating a processing procedure of the setting process in the printer.

FIG. 6 is a diagram illustrating a result display and selection screen.

FIG. 7 is a diagram illustrating a communication sequence between each of the equipment which is performed at time of a setting process according to a second embodiment.

FIG. 8 is a flowchart illustrating a processing procedure of the setting process in the printer according to the second embodiment.

FIG. 9 is a diagram illustrating a result display and selection screen according to the second embodiment.

FIGS. 10A to 10E are diagrams illustrating inquiry screens for setting non-setting information according to the second embodiment.

### DESCRIPTION OF EXEMPLARY EMBODIMENTS

Hereinafter, the embodiments of the invention will be described with reference to the drawings. However, such embodiments are not limited to the technical scope of the invention. Further, identical or similar elements shown in the drawings are described by assigning them the same reference numbers or reference symbols.

### First Embodiment

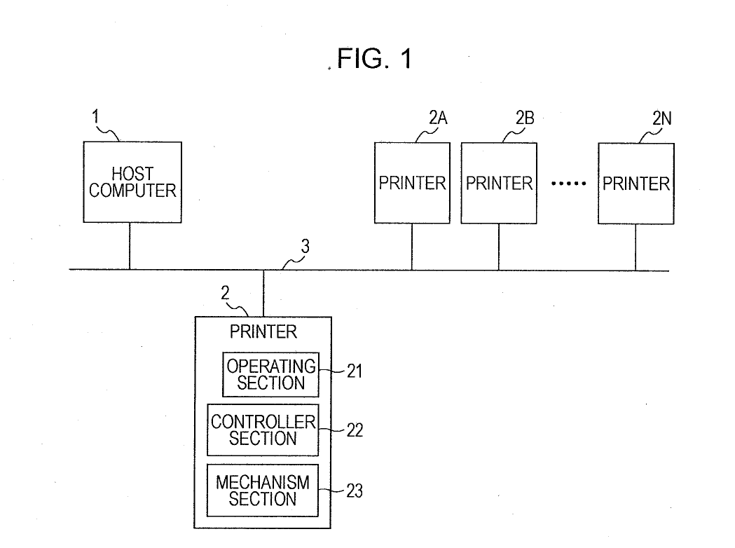

FIG. 1 is a configuration diagram according to a first embodiment of an image processing apparatus to which the invention is applied. A printer 2 shown in FIG. 1 is an image processing apparatus to which the invention is applied, and is intended to perform setting processes of other image processing apparatuses (printers 2A, 2B, 2N) to be connected to a network 3 by a method including copying of content, which is set in the corresponding image processing apparatus itself, in response to a user request from a host computer 1 and the like to be connected by the network 3, and to realize the setting processes having high user convenience.

As shown in FIG. 1, the printer 2 is in an environment in which it is connected to the host computer 1 and a plurality of printers 2A, 2B, 2N via the network 3.

The host computer 1 is constituted by a personal computer and the like, and is a host device of the printer 2 and the printers 2A, 2B, 2N. Although not shown in the drawing, two or more host computer may exist in the network 3. When trying to perform the setting processes for use in the environment of the network 3 with respect to any of the printers 2A, 2B, 2N, a user is able to perform the request on the printer 2 from the host computer 1. Meanwhile, as such a configuration, the host computer 1 is provided with a general browser of the Internet.

Next, the printer 2 is a laser printer as an example, the setting process capable of being used in the network 3 is previously performed. The printer 2 includes a controller section 22, a mechanism section 23, and an operating section 21, as shown in FIG. 1.

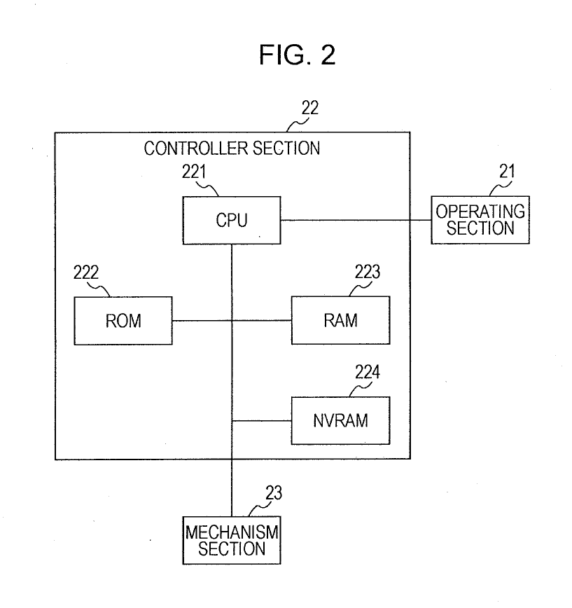

The controller section 22 is responsible for processing and the like of receiving a printing request from the host computer 1 and the like and issuing printing instructions to the mechanism section 23. FIG. 2 is a configuration diagram of the controller section 22. As showing in the drawing, the controller section 22 includes a CPU 221, a ROM 222, a RAM 223, a NVRAM 224 (nonvolatile memory), and an ASIC, not shown, which is responsible for interfacing with the mechanism section 23, and the like. In addition, the controller section 22 has a function of performing the setting processes on other printers 2A, 2B, 2N, and specific detail thereof will be described later. Meanwhile, a process performed by the controller section 22 is mainly executed by an operation of the CPU 221 in accordance with a program stored in the ROM 222.

The mechanism section 23 includes a photosensitive drum, a charging unit, an exposure unit, a developing device, a transfer unit and the like, although they are not shown in the drawing. In execution of printing, the photosensitive drum is charged by the charging unit, and a beam of light from a light source such as a laser or an LED array and the like which is built in the exposure unit hits the charged photosensitive drum to thereby form a latent image by static electricity. After that, the latent image is developed to a developer image by the developing device including a toner cartridge which receives developer (toner), and the toner image developed by the transfer unit is transferred to a printing medium such as paper, is fixed by a fixing unit, and is discharged outside the printer 2.

The operating section 21 is a section in which one interface of the printer 2 and the user is formed, and includes a display panel composed of a liquid crystal panel and the like, and various types of operation buttons. Using the operating section 21, the user is able to request the setting processes with respect to the printer 2 and the other printers 2A, 2B, •••, 2N.

Next, the other printers 2A, 2B, •••, 2N are image processing apparatuses which are objects of the setting process to be performed by the printer 2, and include printers of which the setting process is previously completed so as to be capable of being used in the environment of the network 3, and printers of which the setting process is not performed yet. In addition, the model of the printer is not necessarily the same model as that of the printer 2.

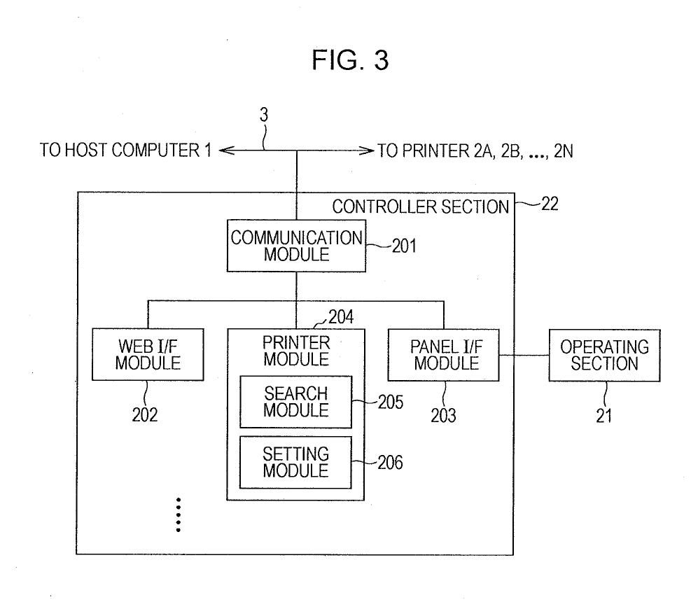

FIG. 3 is a functional configuration diagram with respect to a section in which the above-mentioned setting process of the printer 2 is performed. Meanwhile, FIG. 3 shows only a portion of the function which the controller section 22 assumes. As shown in the drawing, the controller section 22 is provided with a communication module 201, a Web • I/F module 202, a panel • I/F module 203, and a printer module 204, as sections relating to the setting process.

The communication module 201 is a section which is responsible for communicating via the network 3 with other module, and the host computer 1 or the other printers 2A, 2B, •••, 2N, and is able to correspond to communication in various protocols. Herein, as an example, communication with the host computer 1 and the Web • I/F module 202 is executed in HTTP, and communication with the other printers 2A, 2B, •••, 2N and the printer module 204 is executed in exclusive protocol for the printer.

The Web • I/F module 202 is a section that provides a user interface in the case where the setting request is performed from the host computer 1, and generates and transmits a Web page displayed on the display device of the host computer 1 with respect to the browser included in the host computer 1.

The panel • I/F module 203 is a section that provides a user interface in the case where the setting request is performed from the above-mentioned operating section 21 of the printer 2, and is responsible for displaying on the display panel of the operating section 21, receiving a user operation on the operation buttons, and the like.

The printer module 204 is a section that executes processes of the other printers 2A, 2B, •••, 2N at the time of the above-mentioned setting process, and includes a search module 205 and a setting module 206 as shown in the drawing. The search module 205 is a section that searches which printer being connected to the network 3, and the setting module 206 is a section that executes the setting processes of the other printers 2A, 2B, •••, 2N on the basis of a user request.

Each of the modules described above is constituted by the CPU 221, the ROM 222, the RAM 223, the NVRAM 224 and the like of the above-mentioned controller section 22. Therefore, the above-mentioned processes of each of the modules are mainly executed by an operation of the CPU 221 in accordance with a program stored in the ROM 222.

The printer 2 having the above-mentioned configuration is characterized in that the setting processes of the other printers 2A, 2B, •••,2N are executed, as described above. Hereinafter, the specific detail thereof will be described.

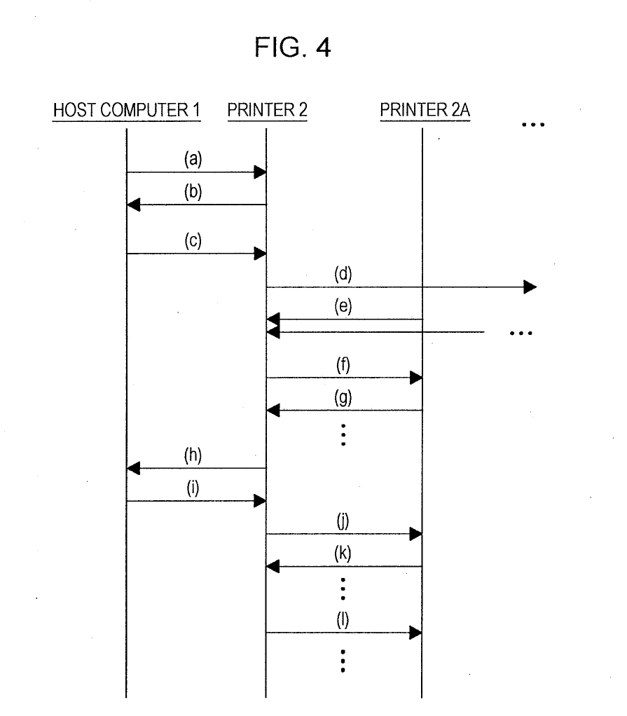

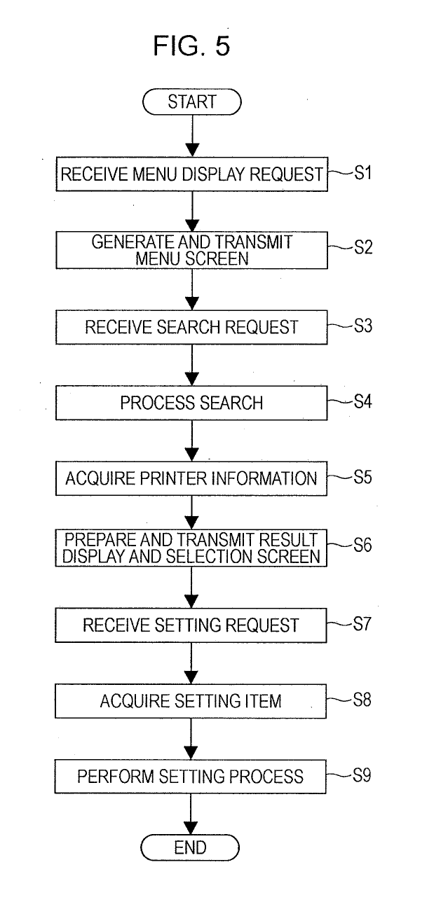

FIG. 4 is a diagram illustrating a communication sequence between each of the equipment which is performed at the time of the setting process, and FIG. 5 is a flowchart illustrating a processing procedure of the setting process in the printer 2. As described above, in the printer 2 itself is so constituted that the setting process is previously performed to be capable of being used in the state of being connected to the network 3, and that predetermined contents are set with respect to each of the setting items relating to the network environment, each of the setting items relating to the printing process, and the like. These setting contents are stored in the NVRAM 224 and the like of the controller section 22. In addition, the setting process of the printer 2 is able to be performed using the operating section 21.

The setting process suitable for the network environment is necessary to be performed, as described above, in order for a user to be capable of using the printer newly connected to the network 3. That is, it is necessary to set contents of various use conditions relating to the network to contents suitable for the network 3. In addition, there are also the setting items (printer settings) relating to the printer itself such as a print mode, a panel display, and a paper feed tray, except the setting items (network settings) relating to the network environment. It is also necessary to perform the settings with respect to these items in order for the user to use them in a desired state.

Therefore, when the user uses a new printer in the network 3, the user requests the setting process of the printer. Although the request may be performed from the operating section 21 of the host computer 1 or the printer 2 as described above, the case where it is performed from the host computer 1 will be described herein.

First, the user accesses the Web I/F module 202 of the printer 2 using the browser of the host computer 1, and requests a menu of the function provided by the printer 2 to be displayed ((a) in FIG. 4). After receiving the request (step Si in FIG. 5), the Web I/F module 202 generates the menu screen, and transmits it to the host computer 1 (step S2 in FIG. 5, and (b) in FIG. 4).

The menu screen is displayed to the user by the browser of the host computer 1. In the screen, the user requests to search the printer 2A, 2B, •••, 2N connected to the network 3 ((c) in FIG. 4).

The request is received by the Web I/F module 202 (step S3 in FIG. 5), and the request is transferred to the search module 205. The request is received, and then the search module 205 executes a search process of the printer connected to the network 3 (step S4 in FIG. 5). In particular, packets for search are broadcasted with respect to the network 3 ((d) in FIG. 4), and the printers 2A, 2B, •••, 2N sending replies ((e) in FIG. 4) are listed up.

After that, the search module 205 acquires printer information of the printers 2A, 2B, •••, 2N which are listed up (step S5 in FIG. 5). In particular, device names of each of the printers are inquired ((f) and (g) in FIG. 4), and MAC addresses of each of the printers are inquired, and then they are acquired.

If the printer information is acquired, the information is delivered to the Web I/F module 202, and a result display and selection screen is prepared by the Web I/F module 202 and are transmitted to the host computer 1 (step S6 in FIG. 5, (h) in FIG. 4). This result display and selection screen is a screen for displaying a result of the search and causing the user to select the printer in which the setting process is performed.

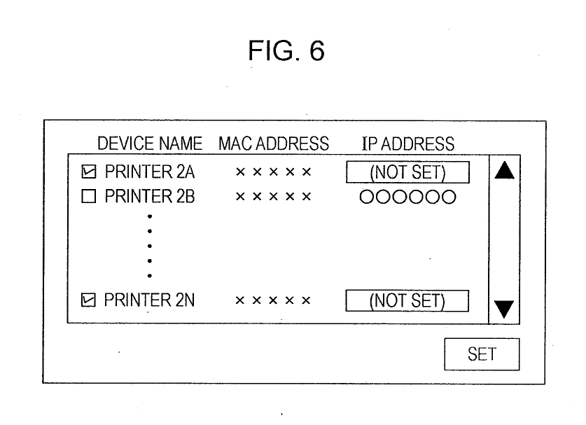

The transmitted screen is displayed to the user by the browser of the host computer 1. FIG. 6 is a diagram illustrating a corresponding result display and selection screen. As shown in the drawing, the printer found in the search are listed up, and the device names, the MAC addressed, and the IP addressed of each of the printers are displayed in the result display and selection screen. Meanwhile, since the IP address is to be set by the setting process being performed in this time, the IP address is not set with respect to a new printer in which the setting process is not performed yet, therefore it is not displayed. In an example shown in FIG. 6, the printer 2A and the printer 2N correspond to the state mentioned above, a display blank of the IP address is provided with an input space.

The user recognizes printers in which the setting process has to be performed in this result display and selection screen, and selects printers in which the setting process is requested. In the example shown in FIG. 6, check boxes located at the left end of the printer to be selected are in a selection state. Herein, the printer 2A and the printer 2N are selected. In addition, at the time of the selection operation, the user inputs the IP addresses of the printers which are collectively selected. After such an operation is finished, the user executes an operation in which the setting processes of the finally selected printers are instructed (requested). In the example of FIG. 6, an operation in which a section of “set” located at the lower right is selected is performed.

In accordance with the operation, the browser of the host computer 1 transmits the setting request including information of the selected printer and the input IP addresses to the printer 2 ((i) in FIG. 4).

The setting request is received by the Web I/F module 202, and the information is transferred to the setting module 206 (step S7 in FIG. 5). The setting module 206 recognizes the other printers in which the setting processes have to be performed in accordance with the information, and acquires information of items to be set from those printers (step S8 in FIG. 5).

In particular, the setting module 206 requests to make a reply to the setting items to each of the printers, and receives the reply from each of the printers ((j) and (k) in FIG. 4). The corresponding communication is plurally performed as necessary. In the example shown in FIG. 6, since the printer 2A and the printer 2N become setting objects, the setting items are respectively acquired from these two printers.

Next, the setting module 206 sequentially executes the setting processes with respect to the acquired setting items (step S9 in FIG. 5). In particular, contents to be set with respect to each of the setting items are transmitted, and the contents are set in predetermined places of the printers (NVRAM and the like included in the other printers). The corresponding communication is plurally executed as necessary ((1) in FIG. 4).

In addition, as the specific setting items, there are items to be set to contents inherent in the devices (printer 2A and the like) in which the setting processes are performed, and items capable of being set to the same contents as those of the printer 2. In the former, there are items (host name, printer name, and the like) generated from the IP address and the MAC address, and items (printer name and the like) generated from the IP address.

Further, in the latter, there are items relating to the network environment, that is, items where the settings are necessary (setting relating to a DNS server, setting relating to a SNMP, setting relating a mail server, and the like) in order to be used in the state of being connected to the network, and items which are not necessary(panel language, panel setting, paper feed tray setting, and the like) in order to be used in the network environment such as the printer setting mentioned above.

The setting module 206 determines the setting values (setting contents) by using the IP address input by the user and the generated MAC address with respect to the setting items inherent in the devices, and performs the above-mentioned setting processes.

In addition, with respect to the setting items capable of being set to the same contents as those of the printer 2, the above-mentioned setting processes are performed as contents to which the setting values (setting contents) set in itself are set unchanged in the other printers. That is, the contents set in itself are copied to the other printers. The above-mentioned printer settings are also included in the setting items to be copied. Typically, a default value is previously set with respect to the items such as the printer settings. As described above, the contents set in the printer 2, which are not necessary setting items in this time, are copied, to thereby allow the other printers 2 to be set to the user's favorite contents set in the printer 2 as well.

Further, in the case where the settings are necessary with respect to the setting items which are not set in the printer 2, such as the case where the other printers 2 which are setting objects and the printer 2 are different in model, it is possible to determine the setting values by methods of causing the user to instruct the setting contents with respect to this, or previously preparing a default value with respect to all the setting items. In the former, the Web I/F module 202 generates a screen for prompting the user to input (select) the setting contents to transmit the screen to the host computer 1, and receives values input by the user with respect to the screen, to deliver the values to the setting module 206.

Further, in the latter case, the Web I/F module 202 accesses a site of a printer maker and the like, that provides the setting items and a default value for them, at a predetermined timing (frequency), and then acquires necessary information, to thereby allow the latest information for them to be held in the NVRAM 224 and the like.

In this way, when the setting processes are completed with respect to the other printers, these printers can be also used in the network 3.

As described above, although there has been described the case where the setting request is performed from the host computer 1, it is possible to perform a similar performance from the operating section 21. In such a case, the above-mentioned panel I/F module 203 executes the information display and the request reception similar to the Web I/F module 202, and cooperates with the printer module 204. In the printer module 204, the process is performed similarly to the above-mentioned case.

In the printer 2 according to the embodiment as describe above, the setting processes with respect to the other printers 2A, 2B, 2N connected to the identical network 3 are executed by the functions included in the controller section 22. Therefore, even in the case where the setting request is performed from the host computer 1, since the request may be transmitted to printer 2 in the host computer 1, and the general browser may be included for the purpose of the corresponding process, it is not necessary to install an exclusive software for the setting process in the host computer 1. Herewith, the time-consuming effort of the user is reduced and the anxiety on the above-mentioned security does not occur as well.

Further, at the time of the setting process, since the content set in the printer 2 is used, the amount of information to be input by the user becomes smaller, and user convenience is improved in this point.

Further, since the setting process is performed with the content of the printer 2 which is previously set by the user even with respect to, for example, the printer settings and the like except the items essential for use in the network environment, the time-consuming effort of the user can be also reduced in this point.

Furthermore, since the user may easily grasp the printer in which the setting process has to be performed by the search process of the printer 2, and may give instructions to selection with respect to the screen also provided with setting instructions, user convenience is high even in this point.

### Second Embodiment

Hereinafter, a second embodiment of the image processing apparatus to which the invention is applied will be described.

The configuration and the functional configuration of the image processing apparatus according to the second embodiment are the same as the configuration and the functional configuration in the first embodiment shown in FIG. 1 to FIG. 3. However, in the second embodiment, the communication sequence between each of the devices which is performed at the time of the setting process, and the processing procedure in the printer 2 of the setting process are different from those of the first embodiment.

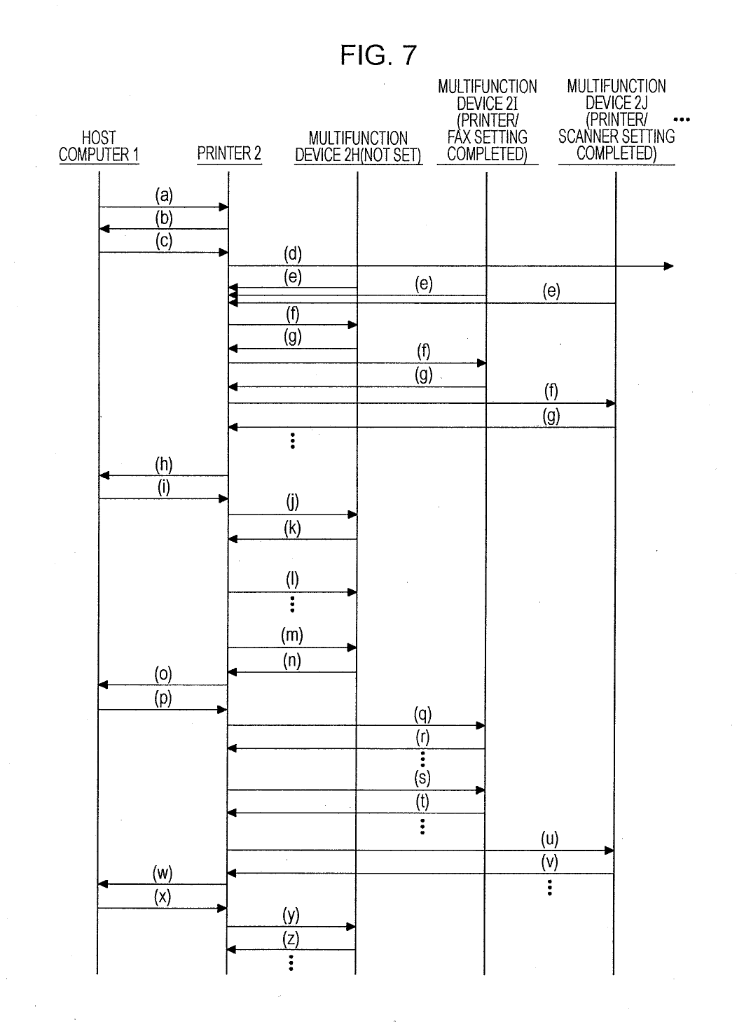

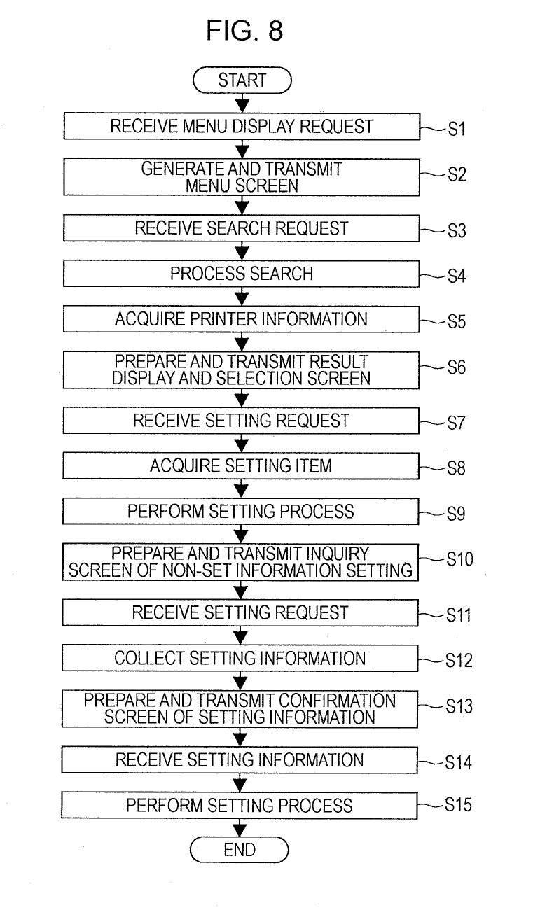

FIG. 7 is a diagram illustrating the communication sequence between each of the devices which is performed at the time of the setting process in the second embodiment, and FIG. 8 is a flowchart illustrating the processing procedure of the setting process in the printer 2 according to the second embodiment.

Here, similarly to the first embodiment, the printer 2 itself shown in FIG. 7 is so constituted that the setting process is performed to be capable of being used in the state of being connected to the network 3, and that predetermined contents are set with respect to each of the setting items relating to the network environment, each of the setting items relating to the printing process, and the like, and are stored in the. NVRAM 224 and the like of the controller section 22.

In addition, a multifunction device 2H, a multifunction device 21 and a multifunction device 2J are connected to the network 3. Here, the multifunction device 2H includes devices of a printer, a FAX and a scanner, and each setting process thereof is in a non-set state. The multifunction device 21 includes devices of a printer and a FAX, and each setting process thereof is in a setting completed state. The multifunction device 2J includes devices of a printer and a scanner, and each setting process thereof is in a setting completed state.

The setting process suitable for the network environment and each setting process relating to the printer, the FAX and the scanner are necessary to be performed with respect to the multifunction device 2H, in order for the user to be capable of using the multifunction device 2H connected to the network 3. Herein, the case where these setting processes are performed from the host computer 1 will be described.

First, the user requests to display a menu of a function provided by the printer 2 using the browser of the host computer 1 ((a) in FIG. 7). The printer 2 receives the corresponding request (step S1 in FIG. 8) and generates a menu screen, and then transmits it to the host computer 1 (step S2 in FIG. 8, (b) in FIG. 7). The user requests to search the devices, which are connected to the network 3, from the menu screen displayed on the host computer 1 ((c) in FIG. 7).

The printer 2 receives the request (step S3 in FIG. 8), and executes the search process the devices connected to the network 3 (step S4 in FIG. 8, (d) and (e) in FIG. 7). The printer 2 acquires printer information of the searched multifunction device 2H, the multifunction device 21 and the multifunction device 2J (step S5 in FIG. 8, (f) and (g) in FIG. 7). At this time, the printer also acquires the device configurations of the multifunction device 2H, the multifunction device 21 and the multifunction device 2J.

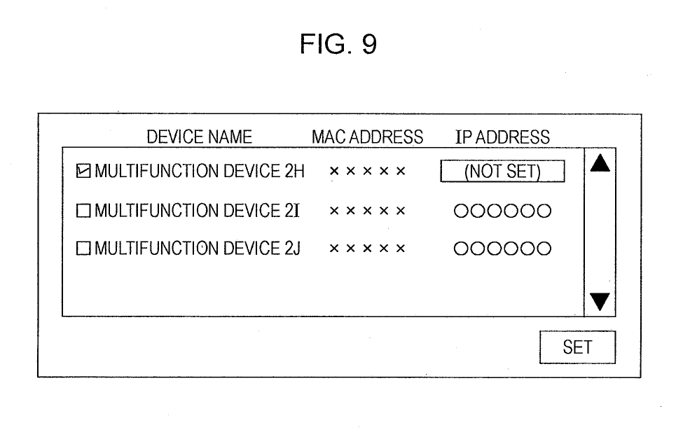

Next, the printer 2 prepares a result display and selection screen on the basis of the printer information and transmits it to the host computer 1 (step S6 in FIG. 8, (h) in FIG. 7). The host computer 1 displays the received result display and selection screen to the user. FIG. 9 is a diagram illustrating the result display and selection screen. As shown in the drawing, the IP address is in a non-set state with respect to the multifunction device 2H. The user selects the multifunction device 2H which is in a non-set state to input the IP address in the result display and selection screen, and then executes an operation in which the setting process is requested.

The host computer 1 transmits the setting request, which includes information of the IP address input by the operation, to the printer 2 ((i) in FIG. 7). The printer 2 receives the setting request (step S7 in FIG. 8), recognizes the multifunction device 2H in which the setting process has to be performed on the basis of the information, and acquires information of items to be set from the multifunction device 2H (step S8 in FIG. 8, (j) and (k) in FIG. 7).

Next, the printer 2 executes the setting process on the multifunction device 2H with respect to the acquired setting items (step S9 in FIG. 8, (1) in FIG. 7). In particular, similarly to the setting process ((1) in FIG. 4) in the first embodiment, the setting values generated on the basis of the input IP address and the MAC address, and the setting values copied from the setting information of the printer 2 are set in the NVRAM and the like of the multifunction device 2H.

Next, the printer 2 requests information indicating a support device and a function thereof to the multifunction device 2H and acquires the information ((m) and (n) in FIG. 7). Since the printer 2 does not have all the information required for the setting process of the multifunction device 2H, the printer prepares an inquiry screen of non-set information setting and transmits it to the host computer 1 (step S 10 in FIG. 8, (o) in FIG. 7).

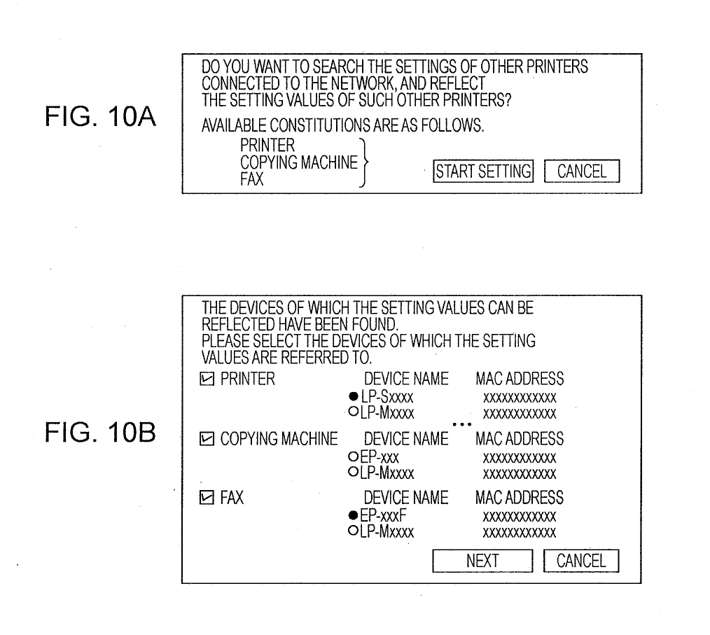

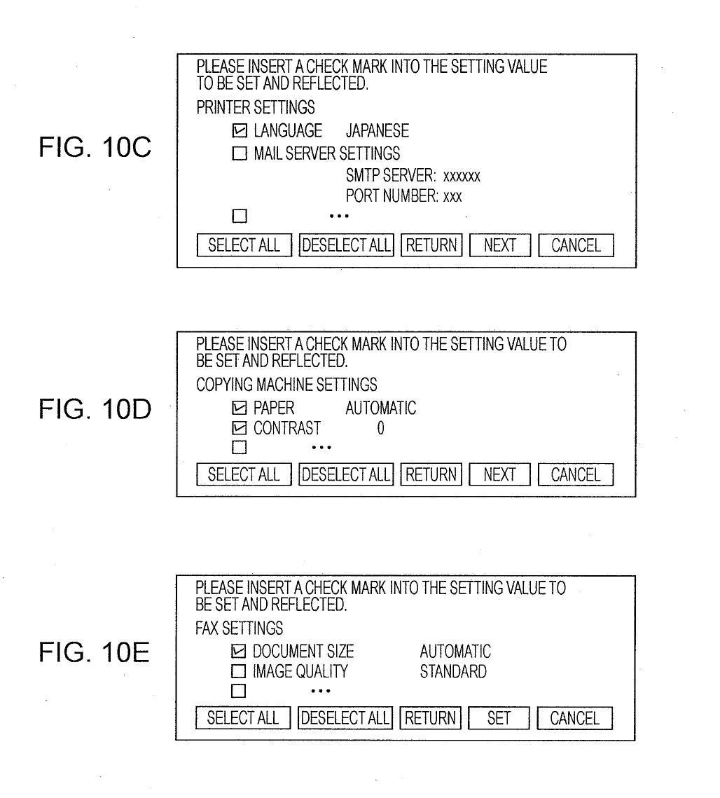

The transmitted screen is displayed on the host computer 1. FIGS. 10A to 10E are diagrams illustrating an inquiry screen of non-set information setting. FIG. 10A is a screen for confirming reflection. In the drawing, the configurations (printer, copy, FAX) based on the types of the support devices acquired from the multifunction device 2H are displayed.

When the user performs an operation of selecting a section of “start setting” of a screen in FIG. 10A, the host computer 1 transmits a setting request to the printer 2 ((p) in FIG. 7). The printer 2 receives the setting request (step S13 in FIG. 8), and collects setting content relating to the printer which is not set in setting information of the printer 2, and setting information of the FAX (step S 12 in FIG. 8, (q), (r), (s) and (t) in FIG. 7). Further, the printer 2 collects setting information of the scanner from the multifunction device 2J (step S12 in FIG. 8, (u) and (v) in FIG. 7).

Next, the printer 2 prepares a confirmation screen of the setting information on the basis of the acquired setting information of the printer, the FAX and the scanner and transmits it to the host computer 1 (step S13 in FIG. 8, (w) in FIG. 7).

The transmitted screen is displayed on the host computer 1. FIG. 10B is a screen for selecting the devices of which the setting values are referred to, and FIGS. 10C to 10E are screens for checking content of the setting values to be reflected. When the user selects the devices referred to in the screen of FIG. 10B and performs an operation of selecting a section of “next”, the screen moves to screens of the corresponding devices of FIGS. 10C to 10E. when the user inserts a check mark into the setting value to be reflected on the screens of FIGS. 10C to 10E, and performs an operation of selecting a section of “set” in the screen of FIG. 10E, the host computer 1 transmits a setting request to the printer 2 ((x) in FIG. 7).

The printer 2 receives the setting request (step S14 in FIG. 8), and executes the setting process on the multifunction device 2H (step S 15 in FIG. 8, (y) and (z) in FIG. 7). Herewith, each of the setting information of the printer, the FAX and the scanner is set in the NVRAM and the like of the multifunction device 211. when the setting process is finished with respect to the multifunction device 2H in this way, it is possible to use printing, copying and FAX in the network 3 with respect to the multifunction device 2H.

Meanwhile, in the above-mentioned setting process of step S9 in FIG. 8, the setting information previously set in the printer 2 is copied and is set in the multifunction device 2H. However, the setting process is not limited thereto, but without using the setting values set in the printer 2, setting information relating to the printer may be acquired from other image processing apparatuses (for example, multifunction device 21) connected to the network 3, to thereby cause the setting information to be set in the multifunction device 2H.

In the printer 2 according to the embodiment as described above, when the setting process is performed on the multifunction device 2H, it is possible to not only copy and use the setting information of the printer 2 (device itself), but also execute the setting process by acquiring the setting information of other image processing apparatuses such as the multifunction device 21 and the multifunction device 2J connected to the identical network 3. Herewith, even when for example, a facsimile, a scanner, and various multifunction devices equipped with a printer function, a copy function, a scanner function and the like are connected to the identical network, it is possible to perform the setting process while reducing the time-consuming effort of the user.

In addition, even when the printer in which the setting process is performed is different from the printer 2 in model, the setting process can be performed, to thereby allow it to be widely used.

Meanwhile, in the embodiment, although the image processing apparatus is a printer, the invention can be also applied to other image processing apparatuses, for example, a facsimile, a scanner, and a multifunction device equipped with a printer function, a copy function, a scanner function and the like, which are capable of being used in the state of being connected to the network.

The protective scope of the invention is not limited to the above-mentioned embodiments, but covers the invention described in the scope of the claims and the equivalents thereof.

The entire disclosure of Japanese Patent Application No. 2009-092274, filed Apr. 6, 2009, and No. 2009-267182, filed Nov. 25, 2009 are expressly incorporated by reference herein.

What is claimed is:

1. An image processing apparatus connected to another image processing apparatus via a network, comprising:
a setting information storing unit that stores setting information;
a request receiving unit that receives a request relating to setting content of the another image processing apparatus; and
a setting unit that executes a setting process of performing setting on the another image processing apparatus on the basis of the setting information stored by the setting information storing unit, in response to the request received by the request receiving unit.

2. The image processing apparatus according to Claim 1, wherein the setting unit executes the setting process by copying the setting information stored by the setting information storing unit to the another image processing apparatus.

3. The image processing apparatus according to Claim 1, wherein the setting unit executes the setting process on the basis of setting content, instructed by a user, which is received by the request receiving unit.

4. The image processing apparatus according to Claim 1, wherein the setting unit executes the setting process on setting content other than setting content relating to an environment of the network.

5. The image processing apparatus according to Claim 1, wherein the setting information stored by the setting information storing unit is setting information relating to a device itself.

6. The image processing apparatus according to Claim 1, wherein another image processing apparatus having setting information relating to a device itself is further connected to the image processing apparatus,
wherein the image processing apparatus further comprises a setting information acquiring unit that acquires the setting information from the another image processing apparatus having the setting information, and
wherein the setting information storing unit stores the acquired setting information.

7. The image processing apparatus according to Claim 1, wherein another image processing apparatus having setting information different from setting information relating to a device itself is further connected to the image processing apparatus,
wherein the image processing apparatus further comprises a setting information acquiring unit that acquires the setting information from the another image processing apparatus having the different setting information, and
wherein the setting information storing unit stores the acquired setting information.

8. The image processing apparatus according to Claim 1, wherein the request receiving unit prepares and transmits a Web page for receiving the request relating to the setting content of the another image processing apparatus, and receives the request relating to the setting content of the another image processing apparatus on the basis of a response to the transmitted Web page.

9. The image processing apparatus according to Claim 8, wherein the setting unit searches the another image processing apparatus connected to the network in response to a search request from a user which is received by the request receiving unit,
wherein the request receiving unit prepares and transmits a Web page that displays the another image processing apparatus connected to the network in a selectable manner as a result of the search, and
wherein the request receiving unit receives a request by selection instructions of the user to a display of the Web page, so that the another image processing apparatus executing the setting process is determined.

10. A method of setting another image processing apparatus in an image processing apparatus connected to the another image processing apparatus via a network, comprising:
receiving a request relating to setting content of the another image processing apparatus; and
executing a setting process of performing setting on the image processing apparatus on the basis of the setting content of the image processing apparatus, in response to the request received by the receiving step.
